(19) United States
(12) Patent Application Publication
(10) Pub. No.: US 2023/0352817 A1
(43) Pub. Date: Nov. 2, 2023

(54) SATELLITE ANTENNA ADJUSTING TRAY ASSEMBLY

(71) Applicant: JONSA TECHNOLOGIES CO., LTD., NANTOU CITY (TW)

(72) Inventor: Ying-Chieh TSENG, NANTOU CITY (TW)

(21) Appl. No.: 17/734,915

(22) Filed: May 2, 2022

(51) Int. Cl. H01Q 1/28; H01Q 1/42

(52) U.S. Cl. CPC H01Q 1/288; H01Q 1/428

(57) ABSTRACT

A satellite antenna adjusting tray assembly has a first tray, a second tray, a rodome, and multiple adjusting assemblies. The first tray has a first plate. The second tray has a second plate. The rodome is connected to the second plate and has a radome. The second plate is disposed between the rodome and the first plate. Each one of the multiple adjusting assemblies connects the first plate with the second plate. Wherein, the first tray and the second tray are floatingly connected with each other.

### BACKGROUND OF THE INVENTION

### 1. Field of the Invention

The present invention relates to a satellite antenna, and more particularly to a satellite antenna adjusting tray assembly.

### 2. Description of Related Art

The satellite antenna is used to receive signals transmitted from the satellite. When the satellite antenna is installed, the orientation of the satellite antenna has to be adjusted according to the orientation of the satellite.

A conventional satellite antenna mounting assembly is capable of adjusting the orientation of the satellite antenna according to the orientation of the satellite. However, the conventional satellite antenna mounting assembly has a lot of parts and is tedious in assembling and adjustment.

Therefore, the numerous parts of the conventional satellite antenna mounting assembly incur inconvenience of installation of the satellite antenna and of adjustment of the orientation of the satellite antenna.

To overcome the shortcomings, the present invention tends to provide a satellite antenna adjusting tray assembly to mitigate or obviate the aforementioned problems.

### SUMMARY OF THE INVENTION

The main objective of the invention is to provide a satellite antenna adjusting tray assembly that has simple structures and is convenient for installation and adjustment.

A satellite antenna adjusting tray assembly comprises a first tray, a second tray, a rodome, and multiple adjusting assemblies. The first tray has a first plate. The second tray has a second plate. The rodome is connected to the second plate. The second plate is disposed between the rodome and the first plate. Each one of the multiple adjusting assemblies connects the first plate with the second plate. Wherein, the first tray and the second tray are floatingly connected with each other.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a satellite antenna adjusting tray assembly in accordance with the present invention;

FIG. 2 is another perspective view of the first embodiment in FIG. 1;

FIG. 3 is an exploded perspective view of the satellite antenna adjusting tray assembly in FIG. 1;

FIG. 4 is another exploded perspective view of the satellite antenna adjusting tray assembly in FIG. 1;

FIG. 5 is a side view of the satellite antenna adjusting tray assembly in FIG. 1;

FIG. 6 is another side view of the satellite antenna adjusting tray assembly in FIG. 1;

FIG. 7 is a perspective view of a second embodiment of a satellite antenna adjusting tray assembly in accordance with the present invention;

FIG. 8 is another perspective view of the first embodiment in FIG. 7;

FIG. 9 is an exploded perspective view of the satellite antenna adjusting tray assembly in FIG. 7;

FIG. 10 is another exploded perspective view of the satellite antenna adjusting tray assembly in FIG. 7;

FIG. 11 is a side view of the satellite antenna adjusting tray assembly in FIG. 7; and

FIG. 12 is another side view of the satellite antenna adjusting tray assembly in FIG. 7.

### DETAILED DESCRIPTION OF PREFERRED EMBODIMENT

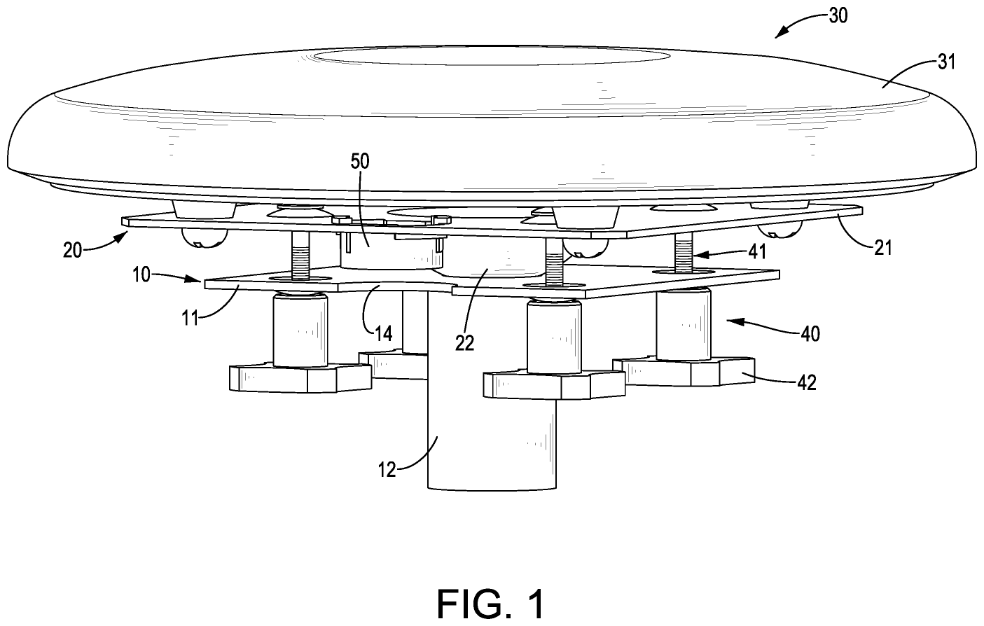

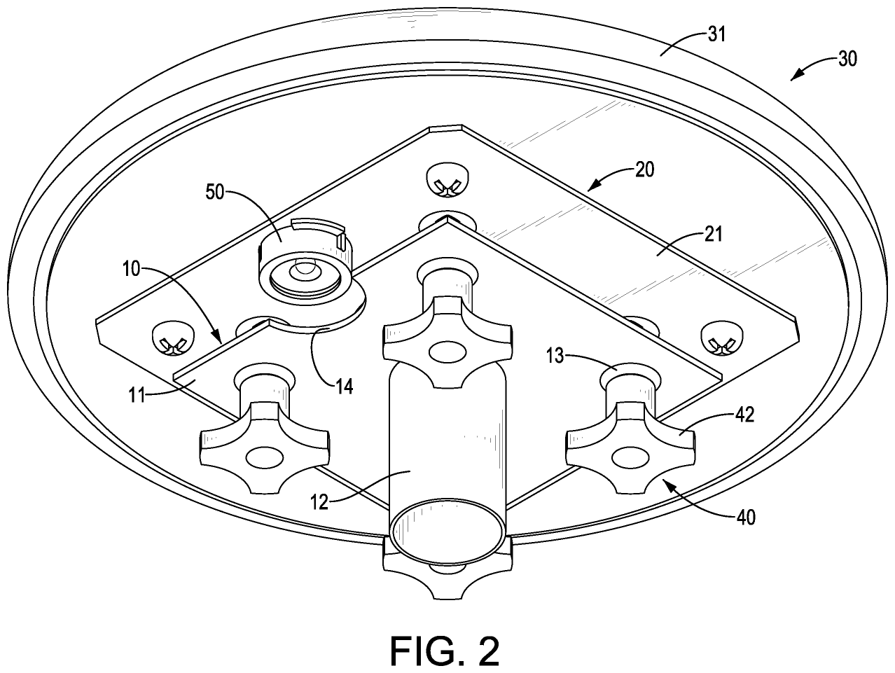

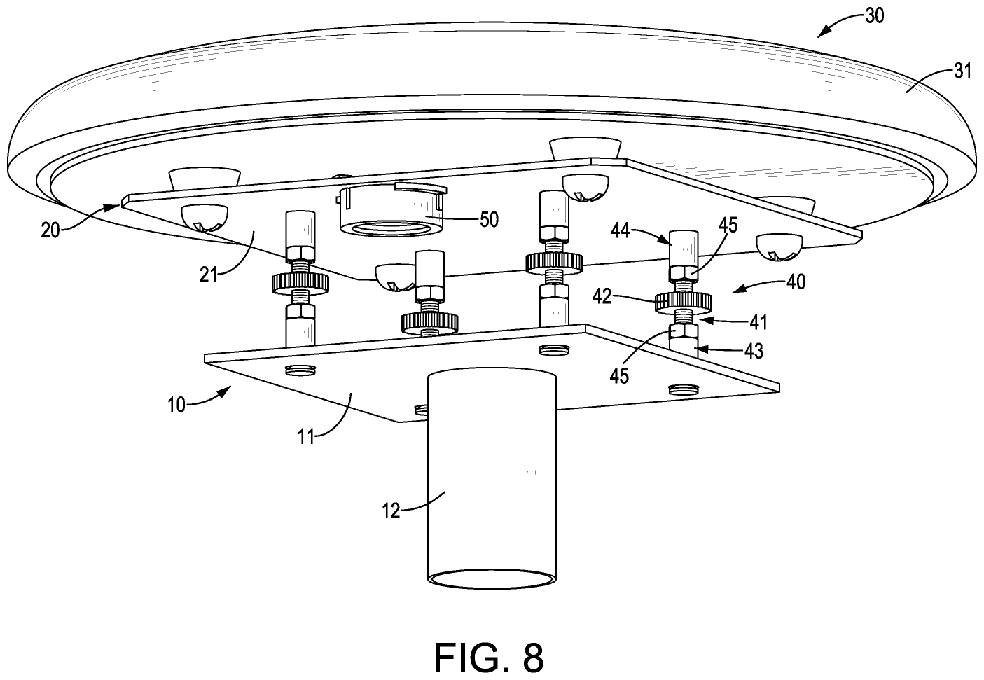

With reference to FIGS. 1, 2, 7, and 8, a satellite antenna adjusting tray assembly in accordance with the present invention has a first tray 10, a second tray 20, a satellite antenna 30, multiple adjusting assemblies 40, a level instrument 50, and an indication 60.

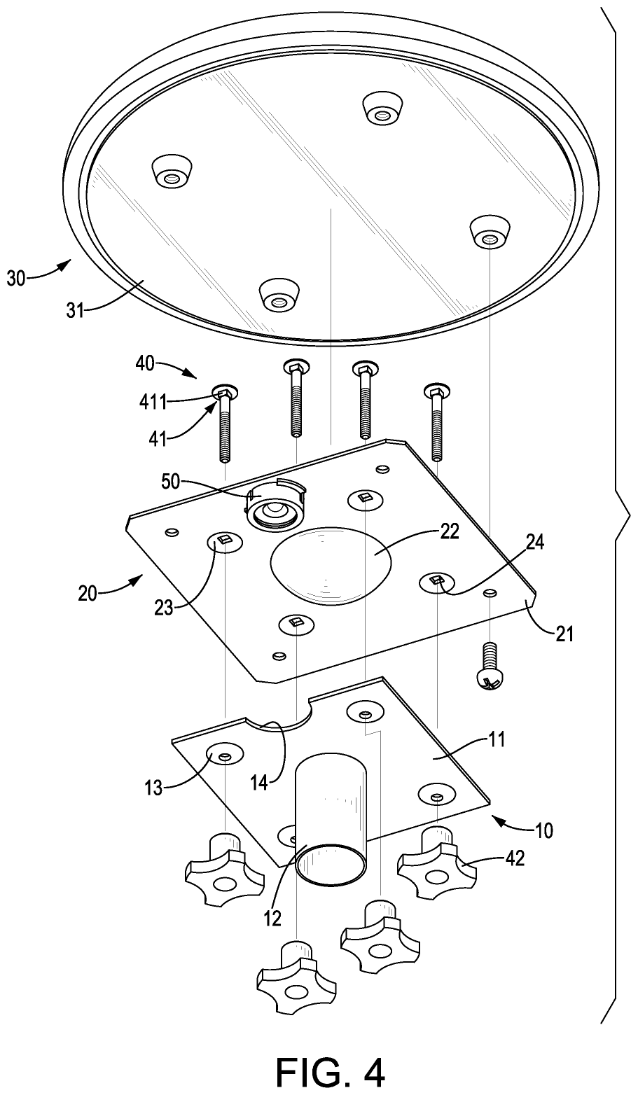

With reference to FIGS. 1 to 4, the first tray 10 has a first plate 11, a tube 12, four first protrusions 13, an observing notch 14, and a positioning recession 15. The first plate 11 is a square plate and has a top surface and a bottom surface respectively facing to an upper side and a lower side of the first plate 11. The tube 12 is a round tube, is disposed at a central portion of the first plate 11, and is fixed to the bottom surface of the first plate 11. The tube 12 is configured to be sleeved on a supporting pole. Each of the first protrusions 13 has a spherical contour and protrudes from the bottom surface of the first plate 11. The four first protrusions 13 surround the tube 12 and are disposed adjacent to an edge of the first plate 11. The observing notch 14 is disposed at the edge of the first plate 11. The positioning recession 15 is disposed at the central portion of the first plate 11, is formed in the top surface of the first plate 11, and has a circular contour.

With FIGS. 1 to 4, the second tray 20 is disposed above the first tray 10. The second tray 20 has a second plate 21, an abutting protrusion 22, four second protrusions 23, and four square holes 24. The second plate 21 is a square plate and has a top surface and a bottom surface respectively facing to an upper side and a lower side of the second plate 21. The abutting protrusion 22 is shaped as a bowl, is disposed at a central portion of the second plate 21, and protrudes from the bottom surface of the second plate 21 toward the first plate 11. The abutting protrusion 22 abuts against a rim of the positioning recession 15 of the first tray 10. The four second protrusions 23 surround the abutting protrusion 22, each of the four second protrusions 23 having a spherical contour and protruding from the top surface of the second plate 21. The multiple square holes 24 are respectively defined through the multiple second protrusions 23, and each square hole 24 has a square outline.

With reference to FIGS. 1 to 4, the satellite antenna 30 is threaded to the top surface of the second plate 21 by bolts. The second plate 21 is disposed between the satellite antenna 30 and the first plate 11. The satellite antenna 30 has a radome 31 for receiving electronic components of the satellite antenna 30.

With reference to FIGS. 1 to 4, each of the adjusting assemblies 40 has a linkage unit 41 and a knob 42. The linkage unit 41 is a bolt and has a threading section and a bolt head. The threading section of the linkage unit 41 is mounted through the second plate 21. The bolt head and the threading section of the linkage unit 41 are isolated from the second plate 21. The bolt head of the linkage unit 41 abuts against the top surface of the second plate 21. The first plate 11 is disposed between the second plate 21 and the knob 42. The knob 42 is screwed with the threading section of the linkage unit 41 and abuts against the bottom surface of the second plate 21. The four adjusting assemblies 40 surround the abutting protrusion 22 of the second tray 20 and are disposed adjacent to an edge of the second plate 21.

With reference to FIGS. 1 to 4, specifically, in the first embodiment of the present invention, the linkage unit 41 of each adjusting assembly 40 is a mushroom head square neck bolt and has a square neck 411 disposed between the bolt head and the threading section of the linkage unit 41. The bolt heads of the linkage units of the adjusting assemblies 40 respectively abut against the second protrusions 23. Square necks 411 of the linkage units 41 of the adjusting assemblies 40 are respectively mounted in and engage with the square holes 24.

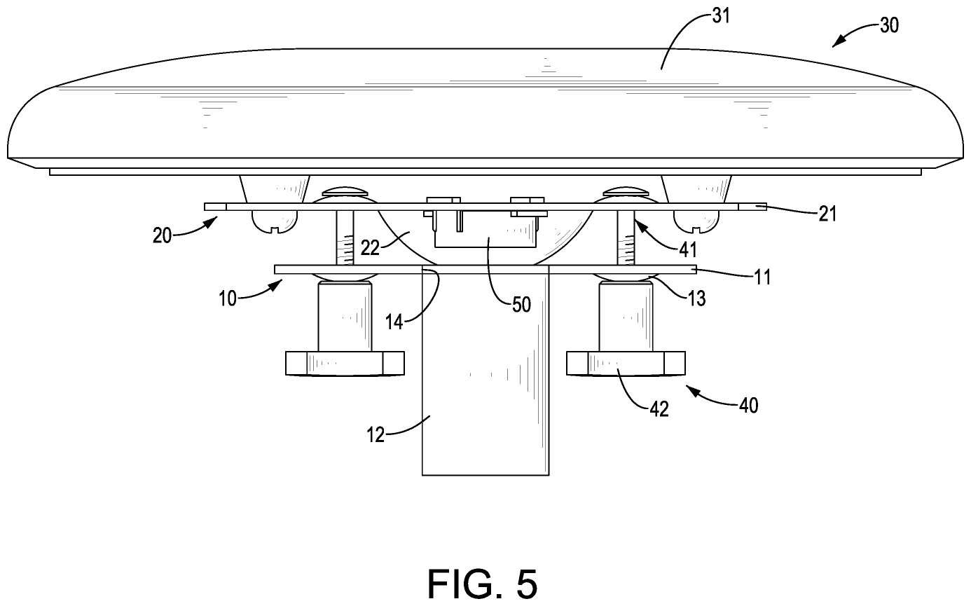

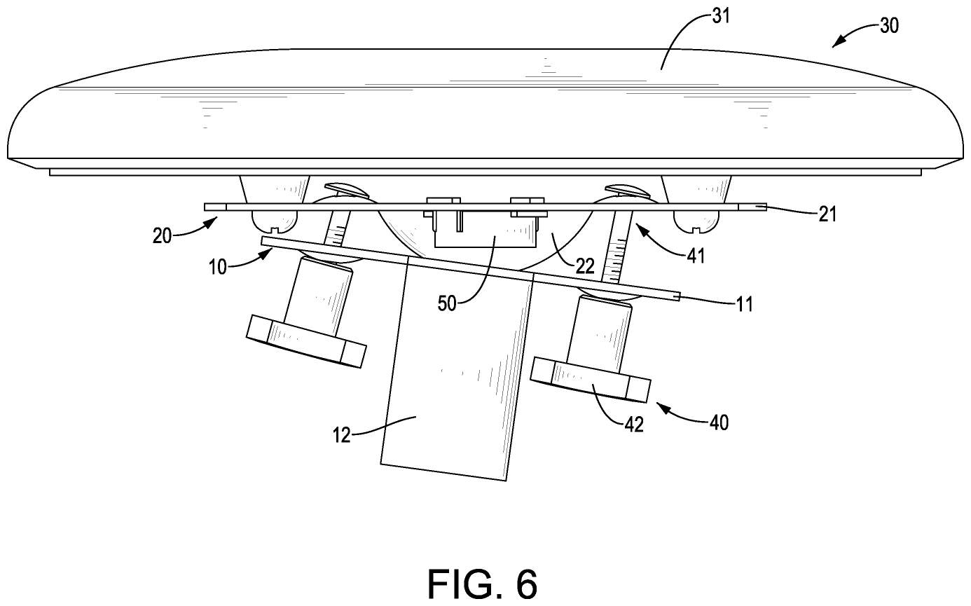

With reference to FIGS. 5 and 6, when the satellite antenna 30 of the present invention needs to be adjusted for good satellite signal reception, the knob of at least one of the adjusting assemblies 40 can be spun to pull the first plate 11 and the second plate 21 close to each other. Therefore, an orientation of the satellite antenna 30 mounted to the second plate 21 is adjusted.

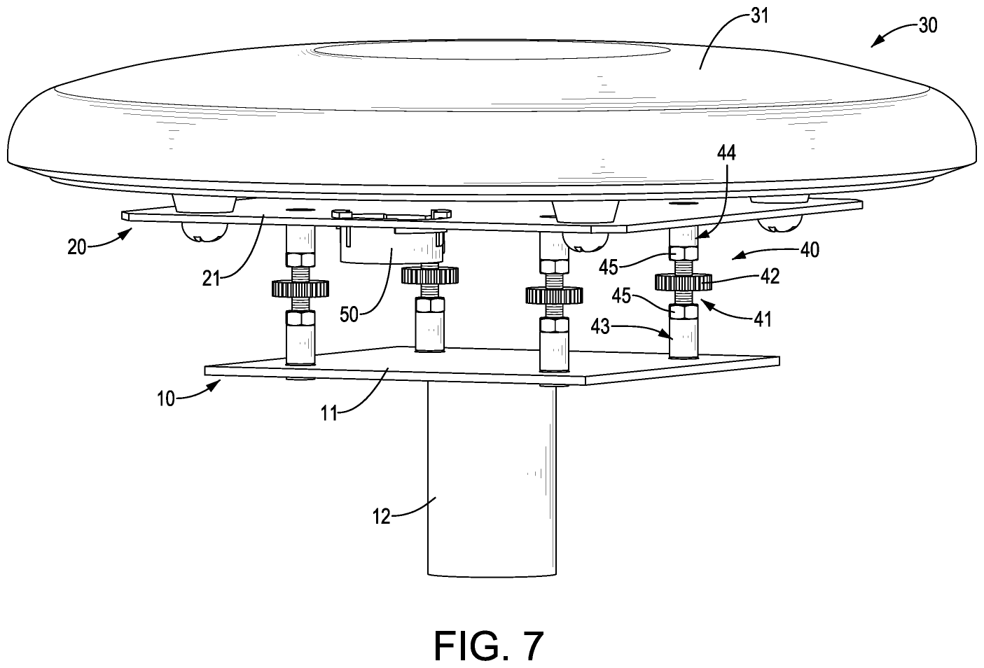

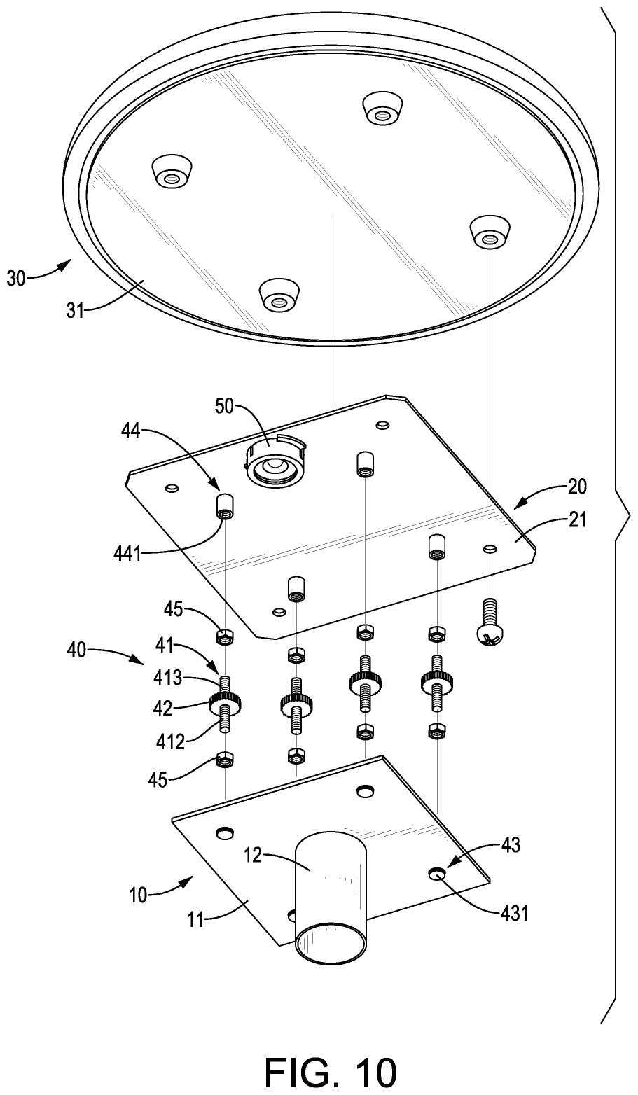

A second embodiment of the present invention is shown in FIGS. 7 to 10. The second embodiment and the first embodiment are similar. In the second embodiment, the first tray 10 omits the four first protrusions 13, the observing notch 14, and the positioning recession 15. The second tray 20 omits the abutting protrusion 22, the four second protrusions 23, and the four square holes 24.

With reference to FIGS. 7 to 10, in the second embodiment of the present invention, each of the adjusting assemblies 40 also has the linkage unit 41 and the knob 42. The first and the second embodiments have the following differences. The linkage unit 41 of each adjusting assembly 40 has a first threading section 412 and a second threading section 413. A thread of the first threading section 412 and a thread of the second threading section 413 are oriented in opposite directions. The knob 42 is disposed at a middle section of the linkage unit 41, between the first threading section 412 and the second threading section 413, and has multiple grooves formed in a circumferential surface of the knob 42.

Furthermore, with reference to FIGS. 7 to 10, in the second embodiment, each of the adjusting assemblies 40 further has a first mount 43 and a second mount 44. The first mount 43 is connected to the first plate 11 and has a universal end 431 and a first threading hole 432 respectively disposed at two opposite ends of the first mount 43. The universal end 431 and the first threading hole 432 are isolated from each other by the first plate 11. The universal end 431 abuts against the bottom surface of the first plate 11 and is a cone gradually tapered toward the first plate 11. The second mount 44 is fixed to the bottom surface of the second plate 21, extends toward the first plate 11, and has a second threading hole 441.

With reference to FIGS. 7 to 10, the first threading section 412 and the second threading section 413 of each adjusting assembly 40 are respectively threaded in the first threading hole 432 of the first mount 43 and the second threading hole 441 of the second mount 44.

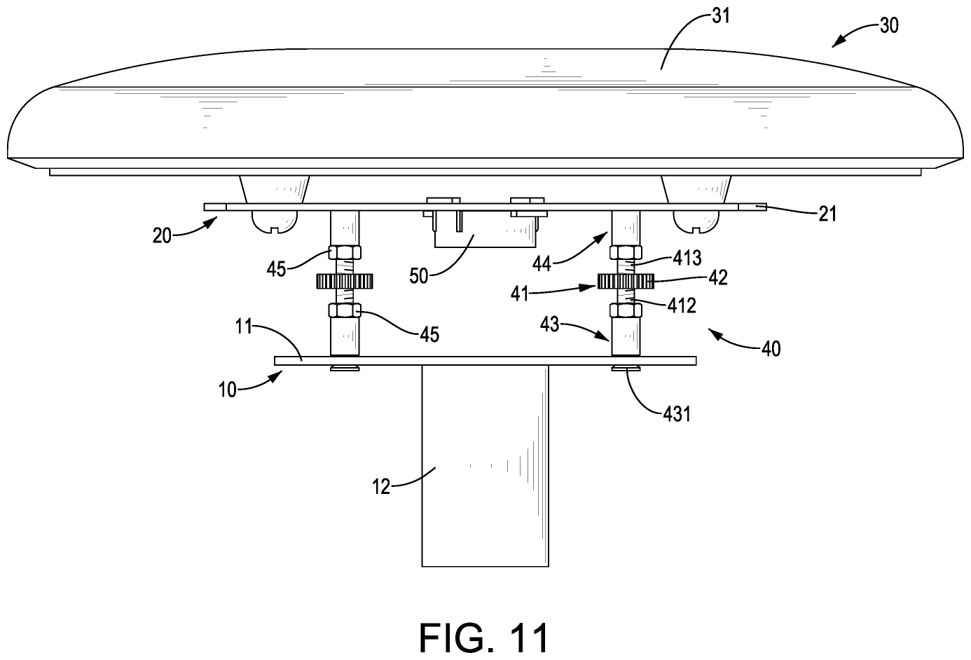

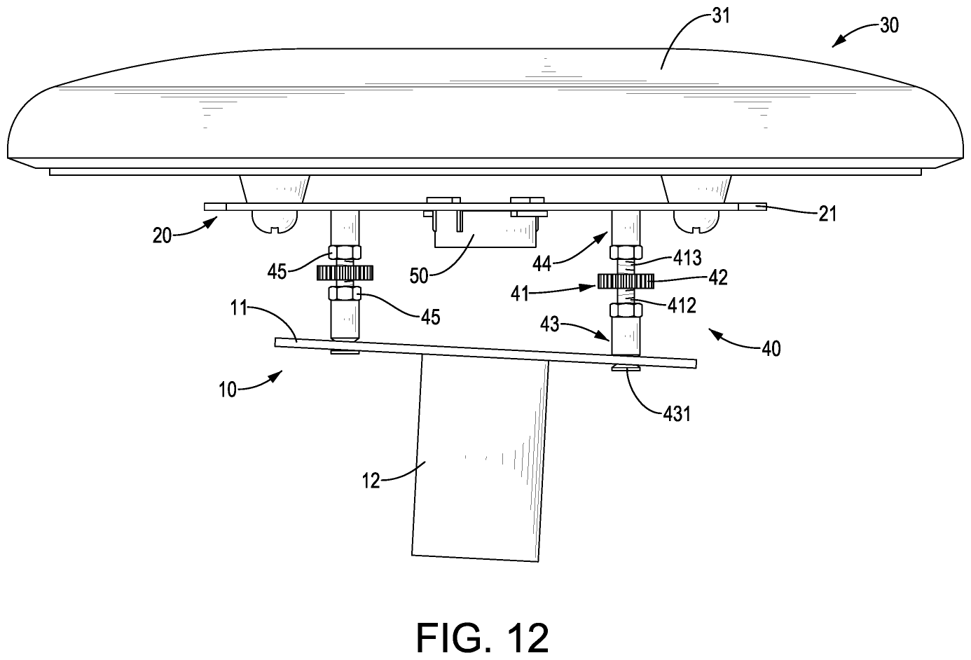

With reference to FIGS. 11 and 12, when the knob 42 of at least one adjusting assembly 40 is spun, the first plate 11 and the second plate 21 are pulled close to each other via the adjusting assembly 40, and the orientation of the satellite antenna 30 mounted to the second plate 21 is adjusted as well.

With reference to FIGS. 11 and 12, in the second embodiment, each adjusting assembly 40 may further have two nuts 45 respectively screwed with the first threading section 412 and the second threading section 413 of the linkage unit 41 of the adjusting assembly 40. After the orientation of the satellite antenna 30 is adjusted, the two nuts 45 can be spun and respectively abut against the first mount 43 and the second mount 44 for fixing the first mount 43 and the second mount 44 to make sure that the orientation of the satellite antenna 30 cannot be changed spontaneously.

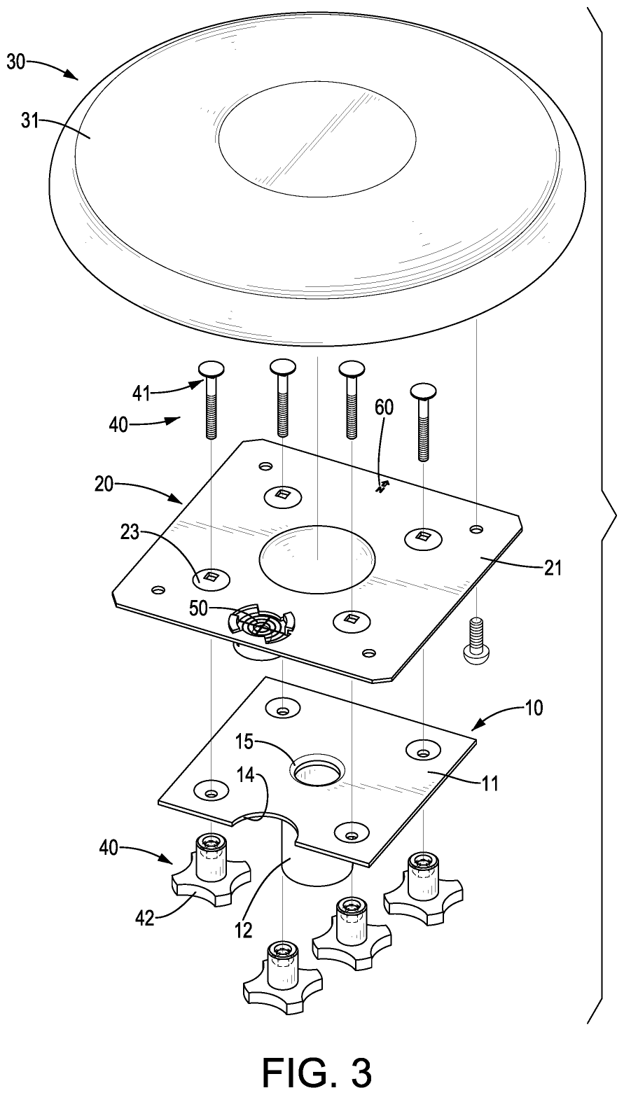

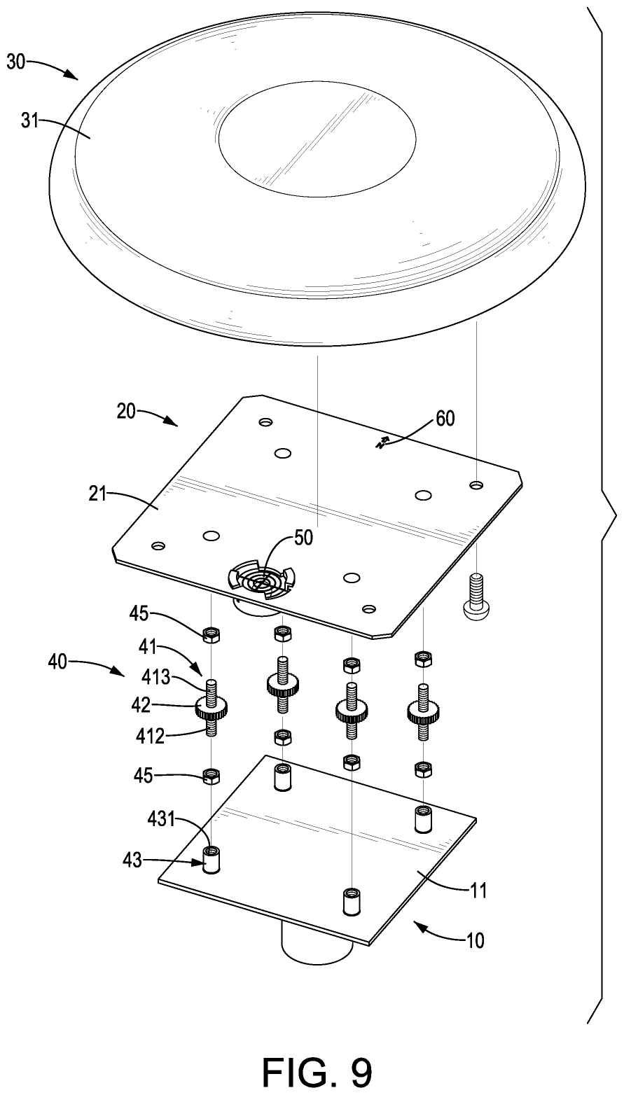

With reference to FIGS. 3, 4, 9, and 10, in the first embodiment and the second embodiment, the level instrument 50 is connected to the second plate 21. With reference to FIGS. 3 and 9, the indication 60 is disposed on the top surface of the second plate 21, adjacent to the edge of the second plate 21, and marked with “N”.

When the satellite antenna 30 is installed, the satellite antenna 30 has to be adjusted according to references of horizontal and azimuth for receiving and transmitting good signals.

A new type satellite antenna mounting assembly needs to have the function of fine-tuning. However, the conventional satellite antenna mounting assembly has to be adjusted for a suitable orientation of the satellite antenna via tedious adjustment by an experienced and skilled installer. The satellite antenna adjusting tray assembly of the present invention has simple structures and is convenient for adjustment Therefore, the present invention indeed be advantageous to installation and adjustment.

After the satellite antenna adjusting tray assembly is assembled to the supporting pole, the second plate 21 is adjusted to make the indication 60 oriented to the north. The level instrument 50 can be observed from the top down for verifying level of the second plate 21. Then, the satellite antenna 30 is mounted to the second plate 21. The level instrument 50 can be observed through the observing notch 14 from the bottom up for verifying the level of the second plate 21 again.

The user can refer to the level instrument 50 for adjusting the orientation of the satellite antenna 30, thereby promoting the convenience of the present invention in use.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A satellite antenna adjusting tray assembly comprising:
a first tray having a first plate;
a second tray having a second plate;
a rodome connected to the second plate, the second plate disposed between the radome and the first plate; and
multiple adjusting assemblies, each one of the multiple adjusting assemblies connecting the first plate with the second plate;
wherein the first tray and the second tray are floatingly connected with each other.

2. The satellite antenna adjusting tray assembly as claimed in claim 1, wherein the second tray has an abutting protrusion shaped as a bowl, disposed at a central portion of the second plate, protruding toward the first plate, and abutting against the first tray.

3. The satellite antenna adjusting tray assembly as claimed in claim 2, wherein
the first tray has a positioning recession disposed at a central portion of the first plate and has a circular contour; and
the abutting protrusion of the second tray abuts against a rim of the positioning recession.

4. The satellite antenna adjusting tray assembly as claimed in claim 3, wherein
each of the multiple adjusting assemblies has
a linkage unit being a bolt and having
a threading section mounted through the second plate and extending toward the first plate; and
a bolt head isolated from the threading section by the second plate and abutting against the second plate; and
a knob screwed with the threading section of the linkage unit and abutting against the first plate, such that the first plate is disposed between the second plate and the knob; and
the multiple adjusting assemblies surround the abutting protrusion of the second tray and are disposed adjacent to an edge of the second plate.

5. The satellite antenna adjusting tray assembly as claimed in claim 4, wherein
the second tray has multiple second protrusions surrounding the abutting protrusion, each of the multiple second protrusions having a spherical contour and protruding from the second plate toward the rodome;
the linkage units of the multiple adjusting assemblies are respectively mounted through the multiple second protrusions; and
the bolt heads of the linkage units of the multiple adjusting assemblies respectively abut against the multiple second protrusions.

6. The satellite antenna adjusting tray assembly as claimed in claim 5, wherein
the second tray has multiple square holes respectively defined through the multiple second protrusions;
the linkage unit of each of the adjusting assemblies is a mushroom head square neck bolt and has a square neck disposed between the bolt head and the threading section of the linkage unit;
the square necks of the linkage units of the multiple adjusting assemblies respectively engage with the multiple square holes.

7. The satellite antenna adjusting tray assembly as claimed in claim 6, wherein
the first plate has multiple first protrusions, each of the multiple first protrusions having a spherical contour and protruding from the first plate away from the second plate; and
the multiple knobs respectively abut against the multiple first protrusions.

8. The satellite antenna adjusting tray assembly as claimed in claim 1, wherein
each of the multiple adjusting assemblies has
a first mount connected to the first plate and having
a first threading hole; and
a universal end disposed opposite the first threading hole, isolated from the first threading hole by the first plate, abutting against the first plate, and being a cone gradually tapered toward the first plate;
a second mount connected to the second plate, extending toward the first plate, and having a second threading hole;
a linkage unit having a first threading section and a second threading section;
a thread of the first threading section and a thread of the second threading section oriented in opposite directions;
the first threading section and the second threading section respectively threaded with the first threading hole and the second threading hole; and
a knob disposed at a middle section of the linkage unit, located between the first threading section and the second threading section, and
having multiple grooves formed in a circumferential surface of the knob.

9. The satellite antenna adjusting tray assembly as claimed in claim 1, wherein the satellite antenna adjusting tray assembly has a level instrument connected to the second plate and disposed adjacent to an edge of the second plate.

10. The satellite antenna adjusting tray assembly as claimed in claim 2, wherein the satellite antenna adjusting tray assembly has a level instrument connected to the second plate and disposed adjacent to an edge of the second plate.

11. The satellite antenna adjusting tray assembly as claimed in claim 3, wherein the satellite antenna adjusting tray assembly has a level instrument connected to the second plate and disposed adjacent to an edge of the second plate.

12. The satellite antenna adjusting tray assembly as claimed in claim 4, wherein the satellite antenna adjusting tray assembly has a level instrument connected to the second plate and disposed adjacent to an edge of the second plate.

13. The satellite antenna adjusting tray assembly as claimed in claim 6, wherein the satellite antenna adjusting tray assembly has a level instrument connected to the second plate and disposed adjacent to an edge of the second plate.

14. The satellite antenna adjusting tray assembly as claimed in claim 7, wherein the satellite antenna adjusting tray assembly has a level instrument connected to the second plate and disposed adjacent to an edge of the second plate.

15. The satellite antenna adjusting tray assembly as claimed in claim 8, wherein the satellite antenna adjusting tray assembly has a level instrument connected to the second plate and disposed adjacent to an edge of the second plate.

16. The satellite antenna adjusting tray assembly as claimed in claim 9, wherein the first adjusting tray has an observing notch disposed at an edge of the first plate according to a position of the level instrument.

17. The satellite antenna adjusting tray assembly as claimed in claim 10, wherein the first adjusting tray has an observing notch disposed at an edge of the first plate according to a position of the level instrument.

18. The satellite antenna adjusting tray assembly as claimed in claim 11, wherein the first adjusting tray has an observing notch disposed at an edge of the first plate according to a position of the level instrument.

19. The satellite antenna adjusting tray assembly as claimed in claim 14, wherein the first adjusting tray has an observing notch disposed at an edge of the first plate according to a position of the level instrument.

20. The satellite antenna adjusting tray assembly as claimed in claim 15, wherein the first adjusting tray has an observing notch disposed at an edge of the first plate according to a position of the level instrument.
